(19) United States
(12) Patent Application Publication
(10) Pub. No.: US 2011/0127978 A1
(43) Pub. Date: Jun. 2, 2011

(54) PWM CONTROLLER WITH LOW UVLO VOLTAGE

(76) Inventors: Wei-Ching LEE, Banciao City (TW); Chi-Hao WU, Hsin-Chu City (TW)

(21) Appl. No.: 12/629,170

(22) Filed: Dec. 2, 2009

(51) Int. Cl. G05F 1/10

(52) U.S. Cl. 323/282

(57) ABSTRACT

The present invention discloses a PWM controller with low UVLO voltage for switching power applications, having a power supply end coupled to a main input voltage via a resistor and coupled to a ground via a capacitor, and an output end coupled to the gate terminal of a primary side transistor requiring a minimum gate voltage, the PWM controller comprising: a UVLO unit; used for performing a hysteresis comparison of a supply voltage at the power supply end with a UVLO_ON voltage and a UVLO_OFF voltage to generate a control signal, wherein the UVLO_OFF voltage can be as low as the minimum gate voltage; a PWM unit, actuated by the control signal to deliver a PWM signal; and a driving stage, comprising a PMOS transistor having a gate coupled to the PWM signal, a source coupled to the supply voltage and a drain coupled to the output end.

### BACKGROUND OF THE INVENTION

1. Field of the Invention

The present invention relates to a PWM controller for switching power applications, and more particularly to a PWM controller with low UVLO voltage for reducing the standby power of switching power applications.

2. Description of the Related Art

In a switching power application like AC-to-DC conversion, a PWM controller, powered by a supply voltage, is used to generate a gating signal to drive a power switch to transfer the power from input to output. During a start-up period, which is required to meet a demanded spec, for example under 3 sec, the supply voltage is rising gradually due to the charging of a hold capacitor through a start-up resistor by a main input voltage, and the gating signal won't be generated until the supply voltage exceeds a high threshold voltage, called UVLO_ON voltage, wherein UVLO is an abbreviation for Under Voltage Lock Out. Once the gating signal is enabled due to the supply voltage exceeding the UVLO_ON voltage, it won't be disabled unless the supply voltage falls below a low threshold voltage, called UVLO_OFF voltage.

Recently, as the green power demand prevails, the switching power applications are required to have standby power reduced to as small as possible, for example 100 mW. To meet this requirement, the resistance of the start-up resistor has to be enlarged. However, the enlarged start-up resistance will consequently cause a longer start-up period which may contradict the start-up period requirement.

To be more specific, please refer to FIG. 1, which shows an illustrative block diagram of the primary side circuit of a switching power application comprising a prior art PWM controller. As shown in FIG. 1, the primary side circuit comprises a PWM controller 100, a start-up resistor 105, a hold capacitor 106, a primary side coil 107, a primary side NMOS transistor 108 and a current sensing resistor 109.

In the primary side circuit, the PWM controller 100, powered by a supply voltage Vcc, is used to generate a gating signal V_{G} for the primary side NMOS transistor 108 according to a current sensing signal Vcs, which is the voltage across the current sensing resistor 109, and a feedback signal V_{FB}, which is an error signal of an output voltage with respect to a reference voltage (not shown in FIG. 1). The PWM controller 100 comprises a UVLO unit 101, a PWM unit 102, a high side NMOS transistor 103 and a low side NMOS transistor 104.

The UVLO unit 101 is used to perform a hysteresis comparison of the supply voltage Vcc at the power supply end with a UVLO_ON voltage and a UVLO_OFF voltage to generate a control signal EN having an enable state and a disable state, wherein the UVLO_OFF voltage must be higher than (the minimum gate voltage of the primary side NMOS transistor 108+the threshold voltage of the high side NMOS transistor 103) to ensure safe operation of the primary side NMOS transistor 108. After power-on, the supply voltage Vcc rises gradually from a level lower than the UVLO_ON voltage and the control signal EN is in the disable state; when the supply voltage Vcc exceeds the UVLO_ON voltage, the control signal EN is changed to be and remain in the enable state unless the supply voltage Vcc falls below the UVLO_OFF voltage. That is, the UVLO_ON voltage and the UVLO_OFF voltage are used as threshold voltages to determine onset and shutoff of the regulation process of the supply voltage Vcc respectively. For typical value, the UVLO_ON voltage is around 15V, the UVLO_OFF voltage is around 9V, the minimum gate voltage of the primary side NMOS transistor 108 is around 7V, and the threshold voltage of the high side NMOS transistor 103 is around 2V.

The PWM unit 102, powered by the supply voltage Vcc, is enabled to deliver a pair of complementary PWM signals V_{H} and V_{L} according to the current sensing signal Vcs and the feedback signal V_{FB} when the control signal EN is in the enable state, and disabled when the control signal EN is in the disable state.

The high side NMOS transistor 103 has a gate terminal coupled to V_{H}, a drain terminal coupled to the supply voltage Vcc and a source terminal coupled to the primary side NMOS transistor 108 for generating a high level of the gating signal V_{G}. The low side NMOS transistor 104, for generating a low level of the gating signal V_{G}, has a gate terminal coupled to V_{L}, a drain terminal coupled to the source terminal of the high side NMOS transistor 103 and a source terminal coupled to a reference ground. The high level of the gating signal V_{G} is around (the supply voltage Vcc—the threshold voltage of the high side NMOS transistor 103).

The series connection of the start-up resistor 105 and the hold capacitor 106 is coupled between a main input voltage V_{INT} and the reference ground to provide a start-up current path for the supply voltage Vcc. The typical value of the start-up resistor 105 is 2MΩ, the typical value of the hold capacitor 106 is 10 μF and the typical value of V is 127V or 373V. Given the typical value of 2MΩ, the power consumption in the start-up resistor 105 is around 70 mW when V_{IN} is 373V. To meet the 100 mW standby power requirement of the switching power application, it means that there is only a margin of 30 mW left for the PWM controller 100 and other components, and it is hard to accomplish.

The primary side coil 107 is used to store magnetic energy provided by the main input voltage V_{INT} when the primary side NMOS transistor 108 is on.

The primary side NMOS transistor 108, having a gate terminal coupled to the gating signal V_{G}, a drain terminal coupled to the primary side coil 107 and a source terminal coupled to the current sensing resistor 109, is used as a switch in a primary current path consisting of the primary side coil 107 and the current sensing resistor 109.

The current sensing resistor 109, connected between the source terminal of the primary side NMOS transistor 108 and the reference ground, is used to carry a current of the primary current path to generate the current sensing signal Vcs.

As the power dissipated in the start-up resistor 105 occupies most part of the required standby power consumption of the switching power application, the resistance of the start-up resistor 105 is expected to be as large as possible to reduce the standby power consumption of the switching power application. However, since the resistance of the start-up resistor 105 has to be under a maximum value to meet the spec of the start-up period, for example 3 second maximum, there is difficulty in reducing the standby power consumption of switching power applications.

One way to prevent the increase of the start-up period when the start-up resistor 105 is enlarged is to use a smaller hold capacitor 106, but the smaller hold capacitor 106, holding smaller amount of charges, poses a risk of unable to maintain the supply voltage Vcc above the UVLO_OFF voltage when the pair of complementary PWM signals V_{H} and V_{L} are enabled, and that will fail the switching power operation.

Another way to solve this problem is to lower the UVLO_ON voltage and the UVLO_OFF voltage. However, the lowered UVLO_ON voltage and the lowered UVLO_OFF voltage will result in a lower supply voltage Vcc, and the high level of the gating signal V_{G}, equal to (the supply voltage Vcc—the threshold voltage of the high side NMOS transistor 103 (about 2V)), will also be reduced. For safe operation, the high level of the gating signal V_{G} is required to be higher than a minimum gate voltage to assure the on-resistance of the primary side NMOS transistor 108 held under a specified value, which is determined according to the maximum load current and the power rating of the primary side NMOS transistor 108 for the switching power application. If the high level of the gating signal V_{G} is lower than the minimum gate voltage, there will be over power dissipated in the primary side NMOS transistor 108, and that can damage the primary side NMOS transistor 108.

Therefore, there is a need to provide a solution capable of reducing the standby power consumption without the risk of burning the primary side NMOS transistor for switching power applications.

Seeing this bottleneck, the present invention proposes a novel standby power reduction solution for switching power applications by using a larger start-up resistor and replacing the prior art PWM controller with a PWM controller with low UVLO voltage.

### SUMMARY OF THE INVENTION

One objective of the present invention is to provide a convenient solution for the standby power reduction of switching power applications without violating the start-up period requirement and without the risk of burning the primary side NMOS transistor.

Another objective of the present invention is to provide a PWM controller with low UVLO voltage to reduce the power consumption of switching power applications without the risk of burning the primary side NMOS transistor.

To achieve the foregoing objectives, the present invention provides a PWM controller with low UVLO voltage for a switching power application, having a power supply end coupled to a main input voltage via a start-up resistor and coupled to a reference ground via a capacitor, and an output end coupled to the gate terminal of a primary side transistor which requires a minimum gate voltage for safe operation, the PWM controller with low UVLO voltage comprising: a UVLO unit; used for performing a hysteresis comparison of a supply voltage at the power supply end with a UVLO_ON voltage and a UVLO_OFF voltage to generate a control signal with an enable state and a disable state, wherein the UVLO_OFF voltage can be as low as the minimum gate voltage; a PWM unit, enabled to deliver a PWM signal when the control signal is in the enable state, and disabled to deliver the PWM signal when the control signal is in the disable state; and a driving stage, comprising a PMOS transistor of which a gate terminal is coupled to the PWM signal, a source terminal is coupled to the supply voltage and a drain terminal is coupled to the output end.

To achieve the foregoing objectives, the present invention further provides another PWM controller with low UVLO voltage for a switching power application, having a power supply end coupled to a main input voltage via a start-up resistor and coupled to a reference ground via a capacitor, and an output end coupled to the gate terminal of a primary side transistor which requires a minimum gate voltage for safe operation, the PWM controller with low UVLO voltage comprising: a UVLO unit; used for performing a hysteresis comparison of a supply voltage at the power supply end with a UVLO_ON voltage and a UVLO_OFF voltage to generate a control signal with an enable state and a disable state, wherein the UVLO_OFF voltage can be as low as the minimum gate voltage; a PWM unit, enabled to deliver a PWM signal when the control signal is in the enable state, and disabled to deliver the PWM signal when the control signal is in the disable state; a boost circuit, used to generate an inverted signal of the PWM signal, wherein the high level of the inverted signal is greater than the supply voltage; and a driving stage, comprising an NMOS transistor of which a gate terminal is coupled to the inverted signal, a drain terminal is coupled to the supply voltage and a source terminal is coupled to the output end.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 is an illustrative block diagram of the primary side circuit of a switching power application comprising a prior art PWM controller.

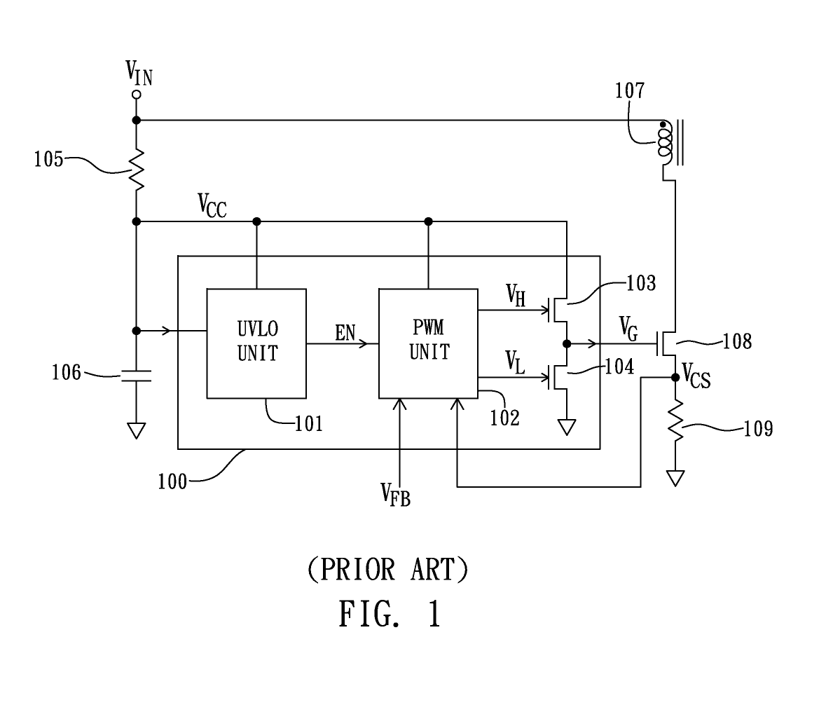

FIG. 2 is an illustrative block diagram of the primary side circuit of a switching power application comprising a PWM controller with low UVLO voltage according to a preferred embodiment of the present invention.

FIG. 3 is an illustrative block diagram of the primary side circuit of a switching power application comprising a PWM controller with low UVLO voltage according to another preferred embodiment of the present invention.

FIG. 4 is a circuit diagram of the boost circuit according to a preferred embodiment of the present invention.

### DETAILED DESCRIPTION OF THE PREFERRED EMBODIMENTS

The present invention will be described in more detail hereinafter with reference to the accompanying drawings that show the preferred embodiment of the invention.

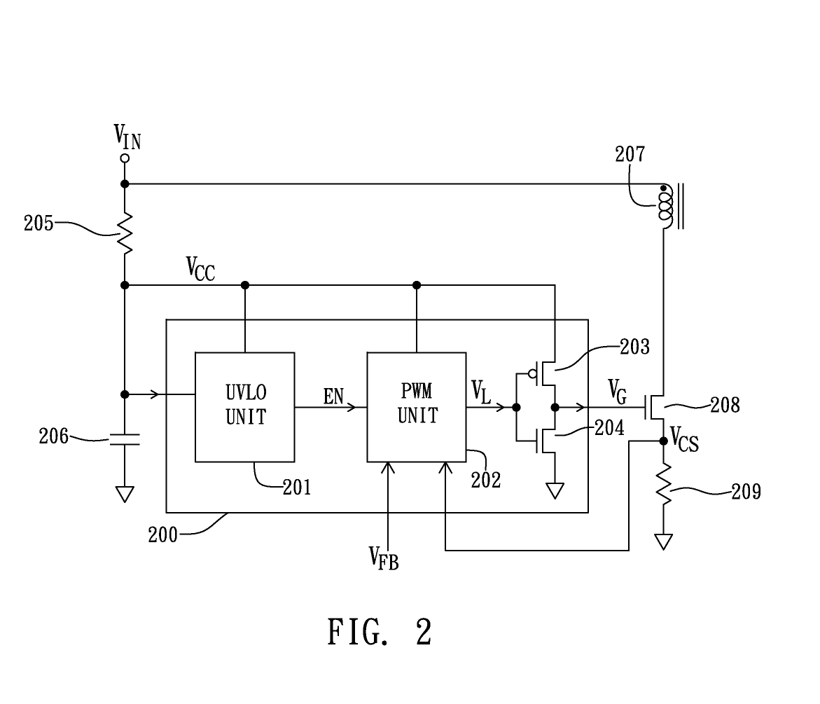

Please refer to FIG. 2, which shows an illustrative block diagram of the primary side circuit of a switching power application comprising a PWM controller with low UVLO voltage according to a preferred embodiment of the present invention. As shown in FIG. 2, the primary side circuit comprises a PWM controller with low UVLO voltage 200, a start-up resistor 205, a hold capacitor 206, a primary side coil 207, a primary side NMOS transistor 208 and a current sensing resistor 209.

In the primary side circuit, the PWM controller with low UVLO voltage 200, powered by a supply voltage Vcc, is used to generate a gating signal V_{G} for the primary side NMOS transistor 208 according to a current sensing signal Vcs, which is the voltage across the current sensing resistor 209, and a feedback signal V_{FB}, which is an error signal of an output voltage with respect to a reference voltage (not shown in FIG. 2). The PWM controller with low UVLO voltage 200 comprises a UVLO unit 201, a PWM unit 202, a high side PMOS transistor 203 and a low side NMOS transistor 204.

The UVLO unit 201 is used to perform a hysteresis comparison of the supply voltage Vcc at the power supply end with a low UVLO_ON voltage and a low UVLO_OFF voltage to generate a control signal EN with an enable state and a disable state, wherein the low UVLO_OFF voltage can be as low as the minimum gate voltage of the primary side NMOS transistor 208, typically around 7V. After power-on, the supply voltage Vcc rises gradually from a level lower than the low UVLO_ON voltage and the control signal EN is in the disable state; when the supply voltage Vcc exceeds the low UVLO_ON voltage, the control signal EN is changed to be and remain in the enable state unless the supply voltage Vcc falls below the low UVLO_OFF voltage. That is, the low UVLO_ON voltage and the low UVLO_OFF voltage are used as threshold voltages to determine onset and shutoff of the regulation process of the supply voltage Vcc respectively, and the supply voltage Vcc can therefore be regulated at a low level which is allowed to be as low as the low UVLO_OFF voltage. The low UVLO_ON voltage helps to provide a smaller value of the start-up period, and the low level of the supply voltage Vcc helps to reduce the power consumption of the PWM controller 200.

The PWM unit 202, powered by the supply voltage Vcc, is enabled to deliver a PWM signal V_{L} according to a current sensing signal Vcs and a feedback signal V_{FB} when the control signal EN is in the enable state, and disabled when the control signal EN is in the disable state.

The high side PMOS transistor 203 has a gate terminal coupled to V_{L}, a source terminal coupled to the supply voltage Vcc and a drain terminal coupled to the primary side NMOS transistor 208 for generating a high level of the gating signal V_{G}. The low side NMOS transistor 204, for generating a low level of the gating signal V_{G}, has a gate terminal coupled to V_{L}, a drain terminal coupled to the drain terminal of the high side PMOS transistor 203 and a source terminal coupled to a reference ground. The high level of the gating signal V_{G} is approximately up to the supply voltage Vcc due to an approximate zero source-drain voltage dropt of the high side PMOS transistor 203 when V_{L} is at a low level. As a result, a low level of the supply voltage Vcc, of which the regulation process is controlled by the low UVLO_ON voltage and the low UVLO_OFF voltage in the UVLO unit 201, can be as low as the minimum gating voltage and is workable for generating a high level of the gating signal V_{G} to meet the minimum gating voltage requirement.

The series connection of the start-up resistor 205 and the hold capacitor 206 is coupled between a main input voltage V_{IN} and the reference ground to provide a start-up current path for the supply voltage Vcc. To meet both the 100 mW standby power requirement and the 3 sec start-up period requirement of the switching power application mentioned above, the resistance of the start-up resistor 205 can be larger than the typical value 2MΩ, for example 4MΩ, with the hold capacitor 206 remained at the typical value 10 μF, thanks to the arrangement of the low UVLO_ON voltage and the low UVLO_OFF voltage in the UVLO unit 201. Given the value of 4MΩ, the power consumption in the start-up resistor 205 is around 35 mW when V_{IN} is 373V, and the start-up period can meet the 3 sec requirement due to the low UVLO_ON voltage.

The primary side coil 207 is used to store magnetic energy provided by the main input voltage V_{IN} when the primary side NMOS transistor 208 is on.

The primary side NMOS transistor 208, having a gate terminal coupled to the gating signal V_{G}, a drain terminal coupled to the primary side coil 207 and a source terminal coupled to the current sensing resistor 209, is used as a switch in a primary current path consisting of the primary side coil 207 and the current sensing resistor 209.

The current sensing resistor 209, connected between the source terminal of the primary side NMOS transistor 208 and the reference ground, is used to carry a current of the primary current path to generate the current sensing signal Vcs.

As the power dissipated in the start-up resistor 205 is substantially reduced and the start-up period requirement is simultaneously complied with, the preferred embodiment of the present invention does solve the problem relating to reducing the standby power consumption of switching power applications. Besides, since the supply voltage of the preferred embodiment of the present invention is lower than that of prior art, the power consumption of the PWM controller is reduced as well.

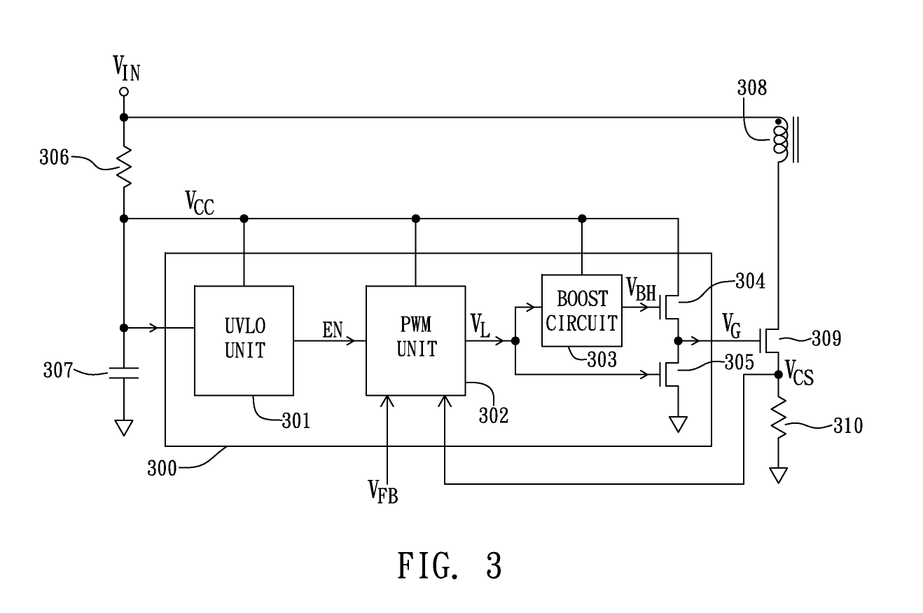

Please refer to FIG. 3, which shows an illustrative block diagram of the primary side circuit of a switching power application comprising a PWM controller with low UVLO voltage according to another preferred embodiment of the present invention. As shown in FIG. 3, the primary side circuit comprises a PWM controller with low UVLO voltage 300, a start-up resistor 306, a hold capacitor 307, a primary side coil 308, a primary side NMOS transistor 309 and a current sensing resistor 310.

In the primary side circuit, the PWM controller with low UVLO voltage 300, powered by a supply voltage Vcc, is used to generate a gating signal V_{G} for the primary side NMOS transistor 309 according to a current sensing signal Vcs, which is the voltage across the current sensing resistor 310, and a feedback signal V_{FB}, which is an error signal of an output voltage with respect to a reference voltage (not shown in FIG. 3). The PWM controller with low UVLO voltage 300 comprises a UVLO unit 301, a PWM unit 302, a boost circuit 303, a high side NMOS transistor 304 and a low side NMOS transistor 305.

The UVLO unit 301 is used to perform a hysteresis comparison of the supply voltage Vcc at the power supply end with a low UVLO_ON voltage and a low UVLO_OFF voltage to generate a control signal EN with an enable state and a disable state, wherein the low UVLO_OFF voltage can be as low as the minimum gate voltage of the primary side NMOS transistor 309, typically around 7V. After power-on, the supply voltage Vcc rises gradually from a level lower than the low UVLO_ON voltage and the control signal EN is in the disable state; when the supply voltage Vcc exceeds the low UVLO_ON voltage, the control signal EN is changed to be and remain in the enable state unless the supply voltage Vcc falls below the low UVLO_OFF voltage. That is, the low UVLO_ON voltage and the low UVLO_OFF voltage are used as threshold voltages to determine onset and shutoff of the regulation process of the supply voltage Vcc respectively, and the supply voltage Vcc can therefore be regulated at a low level which is allowed to be as low as the low UVLO_OFF voltage. The low UVLO_ON voltage helps to provide a smaller value of the start-up period, and the low level of the supply voltage Vcc helps to reduce the power consumption of the PWM controller 300.

The PWM unit 302, powered by the supply voltage Vcc, is enabled to deliver a PWM signal V_{L} according to a current sensing signal Vcs and a feedback signal V_{FB} when the control signal EN is in the enable state, and disabled when the control signal EN is in the disable state.

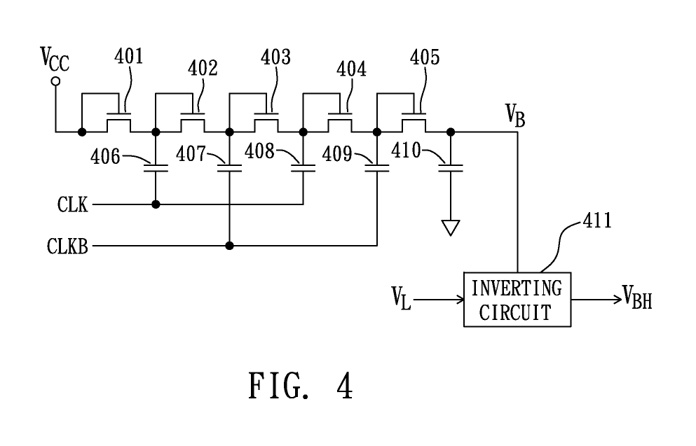

The boost circuit 303 is used to generate a voltage boosted signal V_{BH}, which is an inverted signal of the PWM signal V_{L}, and the high level of the voltage boosted signal V_{BH} is higher than the supply voltage Vcc. FIG. 4 shows a circuit diagram of the boost circuit 303 according to a preferred embodiment of the present invention. As shown in FIG. 4, the boost circuit comprises NMOS transistors 401-405, capacitors 406-410 and an inverting circuit 411. The NMOS transistors 401-405 and the capacitors 406-410 constitute a 4-stage Dickson charge pump, which is operated by a pair of complementary clock signals CLK and CLKB to generate a boosted voltage V_{B} according to the supply voltage Vcc, with V_{B}=Vcc+4(V_{DD}−V_{T})−V_{T}, wherein V_{DD} is the high level of CLK and CLKB, and V_{T} is the threshold voltage of the NMOS transistors 401-405. The inverting circuit 411, powered by the boosted voltage V_{B}, is used to generate the voltage boosted signal V_{BH} according to the PWM signal V_{L}.

The high side NMOS transistor 304 has a gate terminal coupled to V_{BH}, a drain terminal coupled to the supply voltage Vcc and a source terminal coupled to the primary side NMOS transistor 309 for generating a high level of the gating signal V_{G}. The low side NMOS transistor 305, for generating a low level of the gating signal V_{G}, has a gate terminal coupled to V_{L}, a drain terminal coupled to the source terminal of the high side NMOS transistor 304 and a source terminal coupled to a reference ground. The high level of the gating signal V_{G} is approximately up to the supply voltage Vcc due to an approximate zero drain-source voltage dropt of the high side NMOS transistor 304 caused by the voltage boosted signal V_{BH}, of which the high level is higher than the supply voltage Vcc. As a result, a low level of the supply voltage Vcc, of which the regulation process is controlled by the low UVLO_ON voltage and the low UVLO_OFF voltage in the UVLO unit 301, can be as low as the minimum gating voltage and is workable for generating a high level of the gating signal V_{G} to meet the minimum gating voltage requirement.

The series connection of the start-up resistor 306 and the hold capacitor 307 is coupled between a main input voltage V_{N} and the reference ground to provide a start-up current path for the supply voltage Vcc. To meet both the 100 mW standby power requirement and the 3 sec start-up period requirement of the switching power application mentioned above, the resistance of the start-up resistor 306 can be larger than the typical value 2MΩ, for example 4MΩ, with the hold capacitor 307 remained at the typical value 10 μF, thanks to the low UVLO_ON voltage and the low UVLO_OFF voltage in the UVLO unit 301. Given the value of 4MΩ, the power consumption in the start-up resistor 306 is around 35 mW when V_{IN} is 373V, and the start-up period can meet the 3 sec requirement due to the low UVLO_ON voltage.

The primary side coil 308 is used to store magnetic energy provided by the main input voltage V_{IN} when the primary side NMOS transistor 309 is on.

The primary side NMOS transistor 309, having a gate terminal coupled to the gating signal V_{G}, a drain terminal coupled to the primary side coil 308 and a source terminal coupled to the current sensing resistor 310, is used as a switch in a primary current path consisting of the primary side coil 308 and the current sensing resistor 310.

The current sensing resistor 310, connected between the source terminal of the primary side NMOS transistor 309 and the reference ground, is used to carry a current of the primary current path to generate the current sensing signal Vcs.

Again, as the power dissipated in the start-up resistor 306 is substantially reduced and the start-up period requirement is simultaneously complied with, this preferred embodiment of the present invention also solves the problem of reducing the standby power consumption of switching power applications. Besides, since the supply voltage of this preferred embodiment of the present invention is lower than that of prior art, the power consumption of the PWM controller is reduced as well.

Through the implementation of the preferred embodiments of the present invention, a switching power application capable of using a lower hysteresis band of the UVLO voltage is presented. The design of the present invention permits a much larger start-up resistor to be used without violating the spec of the start-up period and without reducing the voltage level of the gating signal for the primary side power switch, so the present invention does conquer the disadvantages of prior art circuits.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures. For example, the 4-stage Dickson charge pump circuit can be replaced with a 2-stage Dickson charge pump circuit or other charge pump circuit; the start-up period is not limited to 3 sec; and the standby power consumption is not limited to 100 mW.

In summation of the above description, the present invention herein enhances the performance than the conventional structure and further complies with the patent application requirements and is submitted to the Patent and Trademark Office for review and granting of the commensurate patent rights.

What is claimed is:

1. A PWM controller with low UVLO voltage for a switching power application, having a power supply end coupled to a main input voltage via a start-up resistor and coupled to a reference ground via a capacitor, and an output end coupled to the gate terminal of a primary side transistor which requires a minimum gate voltage for safe operation, said PWM controller with low UVLO voltage comprising:
a UVLO unit; used for performing a hysteresis comparison of a supply voltage at said power supply end with a UVLO_ON voltage and a UVLO_OFF voltage to generate a control signal with an enable state and a disable state, wherein said UVLO_OFF voltage can be as low as said minimum gate voltage;
a PWM unit, enabled to deliver a PWM signal when said control signal is in said enable state, and disabled to deliver said PWM signal when said control signal is in said disable state; and
a driving stage, comprising a PMOS transistor of which a gate terminal is coupled to said PWM signal, a source terminal is coupled to said supply voltage and a drain terminal is coupled to said output end.

2. The PWM controller with low UVLO voltage as claim 1, wherein said driving stage further comprises an NMOS transistor of which a gate terminal is coupled to said PWM signal, a source terminal is coupled to said reference ground and a drain terminal is coupled to said output end.

3. The PWM controller with low UVLO voltage as claim 1, wherein said primary side transistor is an NMOS transistor.

4. The PWM controller with low UVLO voltage as claim 1, wherein said switching power application is AC-to-DC conversion.

5. A PWM controller with low UVLO voltage for a switching power application, having a power supply end coupled to a main input voltage via a start-up resistor and coupled to a reference ground via a capacitor, and an output end coupled to the gate terminal of a primary side transistor which requires a minimum gate voltage for safe operation, said PWM controller with low UVLO voltage comprising:
a UVLO unit; used for performing a hysteresis comparison of a supply voltage at said power supply end with a UVLO_ON voltage and a UVLO_OFF voltage to generate a control signal with an enable state and a disable state, wherein said UVLO_OFF voltage can be as low as said minimum gate voltage;
a PWM unit, enabled to deliver a PWM signal when said control signal is in said enable state, and disabled to deliver said PWM signal when said control signal is in said disable state;
a boost circuit, used to generate an inverted signal of said PWM signal, wherein the high level of said inverted signal is greater than said supply voltage; and
a driving stage, comprising an NMOS transistor of which a gate terminal is coupled to said inverted signal, a drain terminal is coupled to said supply voltage and a source terminal is coupled to said output end.

6. The PWM controller with low UVLO voltage as claim 5, wherein said driving stage further comprises an NMOS transistor of which a gate terminal is coupled to said PWM signal, a source terminal is coupled to said reference ground and a drain terminal is coupled to said output end.

7. The PWM controller with low UVLO voltage as claim 5, wherein said primary side transistor is an NMOS transistor.

8. The PWM controller with low UVLO voltage as claim 5, wherein said switching power application is AC-to-DC conversion.

9. The PWM controller with low UVLO voltage as claim 5, wherein said boost circuit comprises a charge-pump circuit.

10. The PWM controller with low UVLO voltage as claim 9, wherein said charge-pump circuit is a Dickson charge-pump circuit.
